(19) United States
(12) Patent Application Publication
(10) Pub. No.: US 2004/0083226 A1
(43) Pub. Date: Apr. 29, 2004

(54) System, mehtods, and data structures for transmitting genealogical information

(76) Inventor: Alan Eaton, Springville, UT (US)

Correspondence Address: R. BURNS ISRAELSEN, WORKMAN, NYDEGGER & SEELEY, 1000 Eagle Gate Tower, 60 East South Temple, Salt Lake City, UT, 84111, US

(21) Appl. No.: 10/688,358

(22) Filed: Oct. 17, 2003

Related U.S. Application Data
(63) Continuation of application No. 09/584,462, filed on May 31, 2000.

(51) Int. Cl. G06F 7/00

(52) U.S. Cl. 707/100

(57) ABSTRACT

The present invention provides systems, methods and data structures for transmitting genealogical data across a transmission medium such as the Internet. The genealogical data is stored at a database maintained by a server and when a user requests the genealogical data for a particular pedigree chart, the server generates a data structure that is representative of the individuals in the pedigree chart. The data structure identifies the individuals in the pedigree chart by family relationships and does not contain any genealogical data. The data structure is next transmitted to a client where it is expanded to more fully represent the individuals in the pedigree chart. The expanded data structure not only defines the generations of the pedigree chart but also establishes a link between individuals in the same generation as well as between individuals in adjacent generations. Each individual is represented by a node. The pedigree chart, in the form of nodes, is displayed to a user. The user selects a particular node in the pedigree chart, for example, by mousing over a particular node. When this action or user selection is detected, the genealogical information for that individual is retrieved from the database, displayed to the user, and cached at the client.

### RELATED APPLICATIONS

The present application is a continuation of U.S. patent application Ser. No. 09/584,462 entitled “Systems, Methods, and Data Structures for Transmitting Genealogical Information”, filed on May 31, 2000, which relates to co-pending U.S. patent application Ser. No. 09/583,794 entitled “Systems and Methods for Distributed Genealogical Computing with Centralized Control,” and co-pending U.S. patent application Ser. No. 09/584,619 entitled “System and Method for Using a Graphical Interface for the Presentation of Genealogical Information” both of which were filed on May 31, 2000 and are incorporated by reference in their entirety.

### BACKGROUND OF THE INVENTION

1. The Field of the Invention

The present invention relates to systems, methods and data structures for transmitting data. More specifically, the present invention relates to systems, methods and data structures for transmitting large quantities of genealogical data to a client over a transmission medium such as the Internet.

2. The Prior State of the Art

The need for access to genealogical information is increasing as more people search to uncover their ancestry and their history. People involved with genealogy have discovered that a significant amount of work and research is required in order to collect and gather information about their families and ancestors. Usually, people are searching for identifying information about their family such as names, dates and places of birth and death and the like, but some people are interested in discovering other types of information as well such as religious information and the like.

Many different organizations and people have maintained records which may contain information of interest to genealogists, but the records are often scattered, difficult to find, and in some instances, difficult to read. While the development of computers has allowed information in general to be more easily obtained and distributed, the ability to distribute genealogical information using computers has proved to be more difficult because a significant amount of genealogical information is not readily available, but must be searched for and found.

Searching for genealogical information is not a trivial task. Frequently, researchers examine old public and religious documents, visit cemeteries, and examine private information in their search for genealogical information. In many cases, much of the work done by these persons is repetitive and is frequently incomplete. Duplication occurs because the information being searched for is frequently widely dispersed and people have no real method of knowing what other people have found. In addition, most researchers do not have easy access to the work or research performed by others. Inaccuracies or incompleteness is often a problem due to the difficulty of reading the names and dates written on older documents and the like. In some instances, inaccuracies are introduced by the researchers themselves who may incorrectly spell a name or a place of birth. Detecting and correcting these duplications and inaccuracies is a large and difficult task because of the sheer volume of genealogical data that may is available. As a result, duplications and inaccuracies are frequently undetected and uncorrected.

Currently, genealogical research is focused on names, dates and places to identify particular individuals. By focusing on these identifying characteristics, simple misspellings are sufficient to confuse researchers and cause repetitive work to be performed. For example, one problem with misspelled names is evident when genealogical work is performed by searching various computer databases that may contain genealogical data. If a name or a place of birth is misspelled, a researcher may conclude that more than one individual is involved. In this case, a wealth of information may be simply ignored, or duplicative information will be entered in the database. As a result, there is no way of knowing whether the genealogical information contained within those databases is accurate. Placing inaccurate or duplicative material in a database creates a conflict that the database is unable to resolve. Further, the conflict is often unknown to researchers.

Another problem with genealogical data is related to the quantity or volume of genealogical data that may be available for use by researchers. For instance, a significant amount of storage is required to store the pedigree chart of a single person because there is a lot of information that is contained or may be expressed by a pedigree or ancestral chart and the amount of information increases as additional generations are added to the chart. More specifically, each person in the chart has personal information such as name, date of birth, place of birth, name of spouse, names of children, names of parents, place of marriage, date of marriage, religious information and the like. Organizing and maintaining this type of information for each person in multiple generations requires a significant amount of storage. Retrieving the personal information can cause the client or user to experience latency while all of the genealogical data is retrieved.

In sum, genealogical research is difficult and time consuming because: people are frequently performing work that has already been performed and identifying persons by names, dates and places; genealogical information is widely dispersed in different physical locations and databases; and it is difficult for researchers to coordinate their research. Additionally, the amount of genealogical information makes it both difficult and time-consuming to access the genealogical data stored on various databases. If the information is accessed over the Internet for example, the user may experience a significant latency or time delay while the personal information of all the persons in the pedigree chart is downloaded to the client and processed. It would therefore be an advance in the art to organize the genealogical data and to facilitate the transmission of genealogical data over a network such as the Internet.

### SUMMARY OF THE INVENTION

Genealogical data is frequently represented and displayed through the use of a pedigree chart, which may be used to show both ancestors and descendants. Through the use of computers, a pedigree chart can more easily contain or represent large quantities of personal information for each individual on the pedigree chart. In addition, the pedigree chart can potentially represent many generations. As previously mentioned, one difficulty associated with these large pedigree charts is transmitting the large quantity of genealogical information represented by the pedigree chart over a transmission medium such as the Internet.

In order to transmit the genealogical information in an efficient manner, the present invention identifies an individual by family relations such as parents, children, siblings, and spouse, rather than identifying an individual by names, dates, and places. A data structure that is based on identifying an individual by family relations is used to begin the process of transmitting the genealogical data. The data structure contains a plurality of nodes and each node in the data structure is representative of an individual. However, rather than containing personal information, each node contains information that links that node to nodes in adjacent generations. In this manner, the nodes form an interlinked data structure, whose links are defined by the relationship between the nodes.

After the nodes have been generated, the nodes are transmitted to a client over the Internet or another transmission medium. Upon receiving the nodes, the client expands the nodes to construct a chart that is representative of genealogical information while the personal information of the individuals represented by the nodes has not yet been transmitted to the client. The data structure defined by the nodes is displayed to the user in the form of a pedigree chart, and when a user selects a particular node within the pedigree chart or data structure, the client interacts with the server such that the personal information corresponding to that node is downloaded to the client. This method takes advantage of the fact that a user is typically working with the personal information of a single individual at a time and does not have a need to view all of the personal information associated with all of the individuals represented by the nodes in the pedigree chart. Thus there is no need to download the personal information for all individuals in the data structure and the personal information is therefore downloaded as needed according to various actions performed by a user.

Because a pedigree chart can potentially contain a very large amount of data, the present invention reduces the amount of time that a user must wait while the data is being transmitted. In fact, the personal information associated with a single node is typically small in comparison to the aggregate personal information of the pedigree chart and as a result, the user effectively has immediate access to the genealogical data. When another individual is selected in the pedigree chart, that individual's personal information is retrieved from the server's database. Any previously retrieved personal information may be cached or otherwise stored by a client. This type of data structure allows a user to quickly and easily access and view the personal information of any individual in a pedigree chart. The amount of data transferred across the Internet is effectively reduced and the experience of the user is enhanced.

The present invention has been primarily described in terms of genealogical information, but the systems, methods and data structures described herein may also applied to data that can be described in terms of relationships. For instance, multi-level marketing, animal progeny, gene sequences, DNA information, and the like are examples of data that may be described in terms of relationships. As a result, these types of data can be transmitted as described above.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

In order that the manner in which the above-recited and other advantages and features of the invention are obtained, a more particular description of the invention briefly described above will be rendered by reference to specific embodiments thereof which are illustrated in the appended drawings. Understanding that these drawing depict only typical embodiments of the invention and are not therefore to be considered to be limiting of its scope, the invention will be described and explained with additional specificity and detail through the use of the accompanying drawings in which:

FIG. 1 illustrates an exemplary system that provides a suitable operating environment for the present invention;

FIG. 2 is a block diagram illustrating an exemplary environment in which the present invention may be implemented;

FIG. 3a is a block diagram illustrating the organization of genealogical data structures;

FIG. 3b illustrates an exemplary data structure representing genealogical data before being transmitted across a network;

FIG. 3c illustrates an exemplary data structure representing genealogical data after being transmitted across a network; and

FIG. 4 is a block diagram depicting a reconstructed pedigree chart and personal information of one or more of the individuals in the pedigree chart.

### DETAILED DESCRIPTION OF THE INVENTION

Rather than identifying individuals based on names, dates and places, the present invention identifies individuals based on family relations. More particularly, an individual may be identified by their parents, children, spouse and siblings. Identifying individuals in this manner is particularly useful in view of the fact that pedigree charts are often formed with respect to particular families.

The genealogical information associated with a pedigree chart can be voluminous and may require a significant amount of time to retrieve from a database. The present invention provides a data structure that comprises a plurality of nodes that are related by the same family relationships that identify an individual. The data structure does not contain any genealogical data, but serves to establish a pedigree chart that can be visually presented to a user and each person represented in the data structure is uniquely identified by an identifier that is used to retrieve the personal information of the identified individual from the database.

The genealogical information for the individuals in the pedigree chart is preferably downloaded on a per-individual basis. When the client or user selects a particular node within the pedigree chart, the genealogical information associated with that node is retrieved from the database and displayed to the user. In this manner, the latency experienced by a user downloading all of the genealogical information associated with a pedigree chart is avoided because a comparatively small amount of genealogical information is being download. The retrieved genealogical information may be cached by the client for future use and may be updated by the client as needed. While the present invention is primarily described in terms of genealogical data, the systems, methods, and data structures of the present invention may be utilized with other types of data such as multi-marketing data, animal progeny data, DNA data, and the like.

The present invention extends to methods, systems and data structures for transferring and transmitting data across a medium such as the Internet. The embodiments of the present invention may comprise a special purpose or general purpose computer including various computer hardware, as discussed in greater detail below.

Embodiments within the scope of the present invention also include computer-readable media for carrying or having computer-executable instructions or data structures stored thereon. Such computer-readable media can be any available media which can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such a connection is properly termed a computer-readable medium. Combinations of the above should also be included within the scope of computer-readable media. Computer-executable instructions comprise, for example, instructions and data which cause a general purpose computer, special purpose computer, or special purpose processing device to perform a certain function or group of functions.

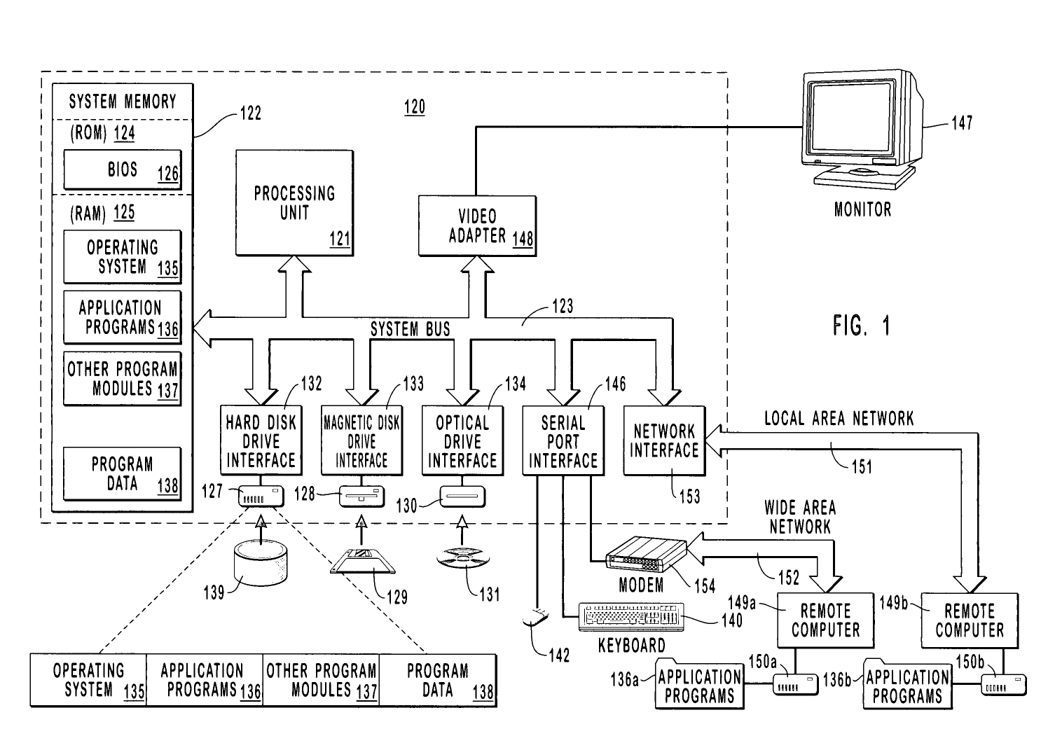

FIG. 1 and the following discussion are intended to provide a brief, general description of a suitable computing environment in which the invention may be implemented. Although not required, the invention will be described in the general context of computer-executable instructions, such as program modules, being executed by computers in network environments. Generally, program modules include routines, programs, objects, components, data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represent examples of corresponding acts for implementing the functions described in such steps.

Those skilled in the art will appreciate that the invention may be practiced in network computing environments with many types of computer system configurations, including personal computers, hand-held devices, multi-processor systems, microprocessor-based or programmable consumer electronics, network PCs, minicomputers, mainframe computers, and the like. The invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

With reference to FIG. 1, an exemplary system for implementing the invention includes a general purpose computing device in the form of a conventional computer 120, including a processing unit 121, a system memory 122, and a system bus 123 that couples various system components including the system memory 122 to the processing unit 121. The system bus 123 may be any of several types of bus structures including a memory bus or memory controller, a peripheral bus, and a local bus using any of a variety of bus architectures. The system memory includes read only memory (ROM) 124 and random access memory (RAM) 125. A basic input/output system (BIOS) 126, containing the basic routines that help transfer information between elements within the computer 120, such as during start-up, may be stored in ROM 124.

The computer 120 may also include a magnetic hard disk drive 127 for reading from and writing to a magnetic hard disk 139, a magnetic disk drive 128 for reading from or writing to a removable magnetic disk 129, and an optical disk drive 130 for reading from or writing to removable optical disk 131 such as a CD-ROM or other optical media. The magnetic hard disk drive 127, magnetic disk drive 128, and optical disk drive 130 are connected to the system bus 123 by a hard disk drive interface 132, a magnetic disk drive-interface 133, and an optical drive interface 134, respectively. The drives and their associated computer-readable media provide nonvolatile storage of computer-executable instructions, data structures, program modules and other data for the computer 120. Although the exemplary environment described herein employs a magnetic hard disk 139, a removable magnetic disk 129 and a removable optical disk 131, other types of computer readable media for storing data can be used, including magnetic cassettes, flash memory cards, digital video disks, Bernoulli cartridges, RAMs, ROMs, and the like.

Program code means comprising one or more program modules may be stored on the hard disk 139, magnetic disk 129, optical disk 131, ROM 124 or RAM 125, including an operating system 135, one or more application programs 136, other program modules 137, and program data 138. A user may enter commands and information into the computer 120 through keyboard 140, pointing device 142, or other input devices (not shown), such as a microphone, joy stick, game pad, satellite dish, scanner, or the like. These and other input devices are often connected to the processing unit 121 through a serial port interface 146 coupled to system bus 123. Alternatively, the input devices may be connected by other interfaces, such as a parallel port, a game port or a universal serial bus (USB). A monitor 147 or another display device is also connected to system bus 123 via an interface, such as video adapter 148. In addition to the monitor, personal computers typically include other peripheral output devices (not shown), such as speakers and printers.

The computer 120 may operate in a networked environment using logical connections to one or more remote computers, such as remote computers 149a and 149b. Remote computers 149a and 149b may each be another personal computer, a server, a router, a network PC, a peer device or other common network node, and typically includes many or all of the elements described above relative to the computer 120, although only memory storage devices 150a and 150b and their associated application programs 136a and 136b have been illustrated in FIG. 1. The logical connections depicted in FIG. 1 include a local area network (LAN) 151 and a wide area network (WAN) 152 that are presented here by way of example and not limitation. Such networking environments are commonplace in office-wide or enterprise-wide computer networks, intranets and the Internet.

When used in a LAN networking environment, the computer 120 is connected to the local network 151 through a network interface or adapter 153. When used in a WAN networking environment, the computer 120 may include a modem 154, a wireless link, or other means for establishing communications over the wide area network 152, such as the Internet. The modem 154, which may be internal or external, is connected to the system bus 123 via the serial port interface 146. In a networked environment, program modules depicted relative to the computer 120, or portions thereof, may be stored in the remote memory storage device. It will be appreciated that the network connections shown are exemplary and other means of establishing communications over wide area network 152 may be used.

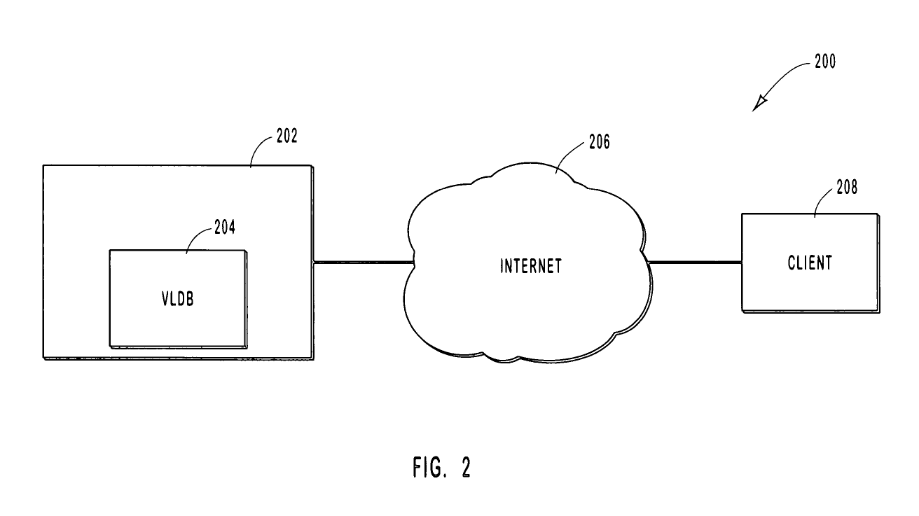

FIG. 2 is an illustration of an exemplary environment in which the systems, methods and data structures of the present invention may be implemented. Other environments not explicitly illustrated or described herein may exist which may also be used to implement the present invention. FIG. 2 illustrates a server computer 202 that has a very large database (VLDB) 204 capable of storing genealogical data. Client 208, which is representative of users and computers connected to the Internet 206, is capable of accessing the genealogical data stored on the database 204 over the Internet 206 or another suitable connection. Client 208 is also intended to represent a software module or program that executes on a user computer.

One example of the type of genealogical data stored in the database 204 is that specified by GEDCOM. In most instances the stored genealogical information corresponds to particular individuals and may be retrieved by identifying that individual. As used herein, “personal information” or “genealogical data” refer to the information stored in the database 204 and may include, but is not limited to, birth dates, marriage dates, places of birth, names, parents, siblings, children, census data, religious data and the like. It is understood that other information not specifically identified herein may also be included in the genealogical data or personal information.

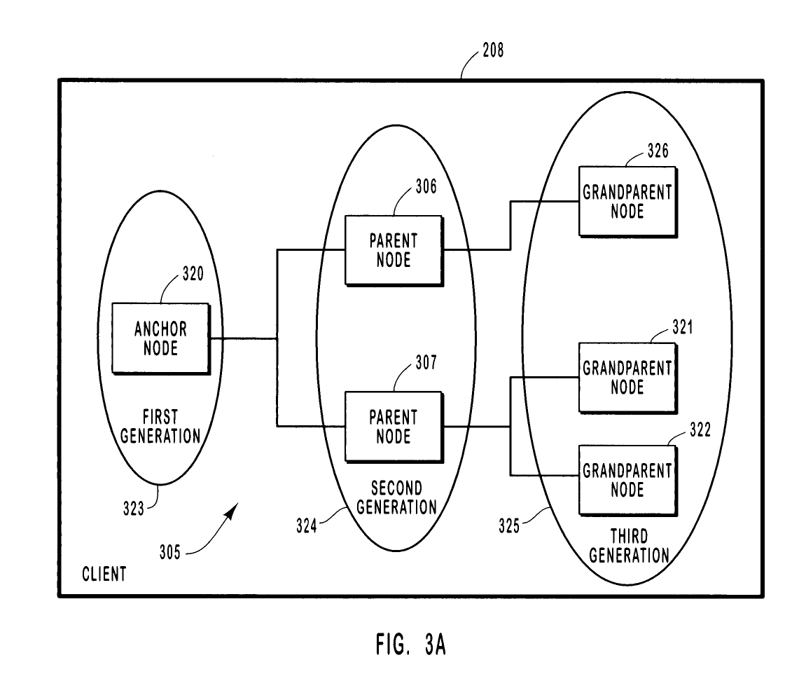

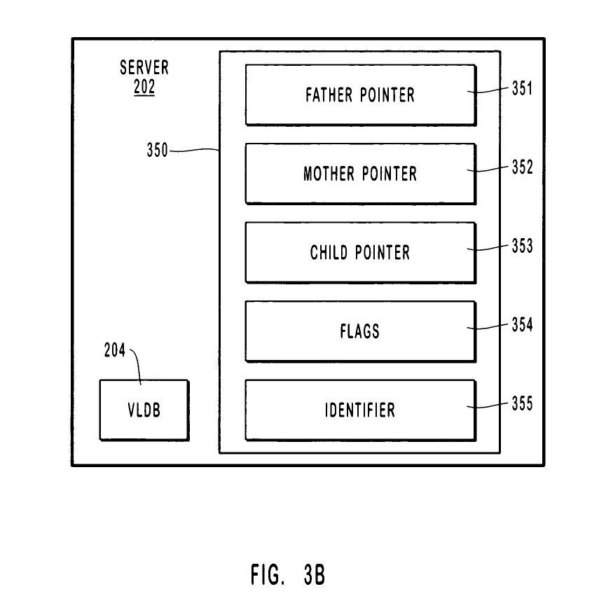

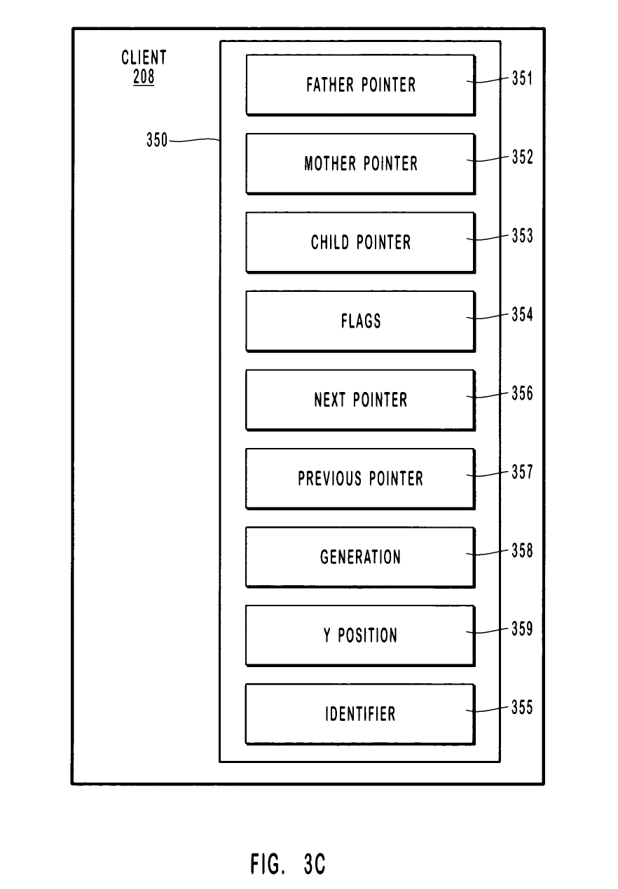

FIG. 3a is an illustration of a genealogical or pedigree chart that is used for ancestral purposes, and while the present invention is discussed in terms of genealogical charts that illustrate ancestry, it is understood that the present invention applies equally to charts illustrating descendants. The chart 305 typically begins with an anchor node 320, which is representative of the individual whose ancestors or descendants are being mapped or charted. The individual represented by the anchor node 320 also constitutes the first generation designated as generation 323. Nodes 306 and 307 correspond to individuals in the second generation 324 and are representative of the parents of the individual represented by node 320. Nodes 321, 322 and 326 correspond to the next or third generation 325 and are representative of the grandparents of the individual represented by anchor node 320 as well as the parents of the individuals represented by nodes 306 and 307. The chart 305 may take other embodiments. For instance, the chart 305 may be arranged to simultaneously show both the ancestors and the descendants of the anchor node 320. Alternatively, the chart 305 may only illustrate the descendants of the anchor node 320.

As illustrated in the chart 305, it is possible that some of the ancestors are not currently known. For example, the generation 325 only contains one parent node 326 for the node 306. Further, chart 305 only shows three generations 323, 324, and 325 and it is possible that more generations are known, but not illustrated. Alternatively, it is possible that nodes 321, 322, and 326 are termination nodes, which would indicate that no further genealogical information is currently known with regard to those nodes. More specifically, a termination node indicates that the next generation is presently unknown. However, the number of generations actually provided or displayed to a user is often selected by the user or may correspond to a default value.

As previously mentioned, the chart 305 may correspond to a large quantity of personal information that may require significant time to transfer from the server to the client. To facilitate the transmission of personal data from the server 202 to the client 208, FIGS. 3b and 3c illustrate a preferred data structure for each of the nodes in the chart 305. More specifically, FIG. 3b illustrates the data structure of the nodes generated or created at the server 202, while FIG. 3c illustrates the data structure of the nodes at the client 208.

When the server 202 receives a request from the client 208 for genealogical data, the database 204 is queried for the requested genealogical data and a group of nodes is created that corresponds to requested genealogical data, each of which corresponds to a particular person. The number of nodes created or produced by the server 202 can vary and frequently depends on the amount of genealogical information requested by the client 208 as well as the amount of genealogical information that is actually available in the database 204. The data structure for each of the nodes is discussed herein with respect to a single node, but it is understood that many nodes are typically generated or created by the server 202 and that each node is representative of a different individual.

The data structure of node 350 reflects that an individual may be identified by family relations including the mother, father, siblings, and children. The preferred data structure of node 350 does not usually rely on dates or places to identify an individual. Thus, node 350 shown in FIG. 3b has a plurality of data fields including but not limited to a father pointer 351, a mother pointer 352, a child pointer 353, flags 354 and an identifier 355. The father pointer 351 is typically a pointer that points to the father of the individual represented by the current node. The mother pointer 352 points to the mother of the individual represented by the current node and the child pointer 353 points to a child of the individual represented by the current node. The flags 354 is typically used to indicate pre-defined qualities or characteristics of the individual and are discussed more fully in co-pending U.S. patent application Ser. No. 09/583,794 titled “Systems and Methods for Distributed Genealogical Computing with Centralized Control,” filed the same day herewith and incorporated herein by reference in its entirety and co-pending U.S. patent application Ser. No. 09/584,619 titled “System and Method for Using a Graphical Interface for the Presentation of Genealogical Information” also filed the same day herewith, which are incorporated herein by reference. The identifier 355 is a globally unique identifier that is specific to an individual and is preferably used to retrieve the personal information of the individual from the database. In other words, every individual in the database 204 has a unique and distinct identifier 355.

In addition to pointing to another node in the chart, the value of some of the data fields may be empty or have a null value. For instance, if node 350 represents the individual whose pedigree chart is being created, then the value of the child pointer 353 will be null, unless the user has chosen to include the descendants in the pedigree chart of the individual, in which case the value of the child pointer 353 will not be null. In fact, there may be multiple child pointers 353, depending on the number of children that the individual has.

If the father is unknown and not stored in the database 204, then the value of the father pointer 351 will also be null. The number of data fields in the node 350 may change for some types of genealogical charts or lineages. For example, the node 350 may have more than one child pointer 353 when a descendant lineage or chart is created. Additionally, it is not necessary that each separate node in the genealogical chart have the same number of data fields. The nodes generated on the server 202 contain enough information to construct a chart that is representative of the relationships between the nodes.

Once the nodes generated on the server 202 have been transmitted to the client 208, the nodes are processed or expanded to produce the chart 305 illustrated in FIG. 3a. In one embodiment, each node receives additional data fields, which may be derived from the existing data fields, including, but not limited to, a next pointer 356, a previous pointer 357, a generation field 358, and a y position 359. The next pointer 356 and the previous pointer 357 are typically used to point to nodes that are in the same generation as opposed to the father, mother and child pointers, which point to nodes in different generations. Because the number of nodes in any given generation is known for purposes of the chart 305, at least one of the next pointers 356 of the nodes in the given generation will be null and at least one of the previous pointers 357 of the nodes in the given generation will also be null.

The generation field 358 is used to determine or identify the generation to which a particular node belongs. Thus, the generation field 358 will be the same for all nodes in the same generation. The y position 359 is often used for display purposes to determine the vertical position of a particular node in a particular generation. In a sense, the generation field 358 and the y position 359 function as coordinates as the chart 305 is being constructed and displayed by the client 208.

A significant advantage of the data structures illustrated in FIGS. 3b and 3c is that the amount of information transmitted to the client 208 is reduced because the client 208 is capable of expanding the nodes generated by the server 202 to generate some of the necessary data fields. The next and previous pointer data field help identify an individual by making the siblings of a selected node or individual known. As a direct result, the transmission time required to transmit the nodes from the server 202 to the client 208 is also reduced and may be even further reduced by compressing the information contained within the various data fields of the nodes. Reducing the amount or volume of data transferred over the Internet in this manner results in a quicker response from viewpoint of the client 208. In other words, the data structure permits less data to be transmitted over the Internet because the data transmitted from the server 202 is expanded at the client 208.

After the nodes have been transmitted, the client 208 is capable of constructing and displaying the chart 305 to a user as illustrated in FIG. 3a. In FIG. 3a, the first generation 323 contains only the anchor node 320. Thus the generation data field of node 320 has a value of one. The generation data fields of nodes 306 and 307 have a value of 2 and the generation data fields of generation 325 have a value of three. The y position data fields for the nodes in each separate generation are used to properly position the nodes on a display device or in a computer readable medium.

With regard to node 306, the father pointer refers to node 326 while the mother pointer is null. The child pointer points to anchor node 320. The next pointer of node 306 points to node 307 and the previous pointer of node 306 is null. Similarly, the pointers contained in the other nodes may be identified. In this manner, all of the nodes illustrated in structure 305 are linked and connected to form a single larger data structure having a plurality of linked nodes. The organization of structure 305 is closely linked with the concept that an individual may be uniquely identified by that individual's parents, siblings, spouse and children.

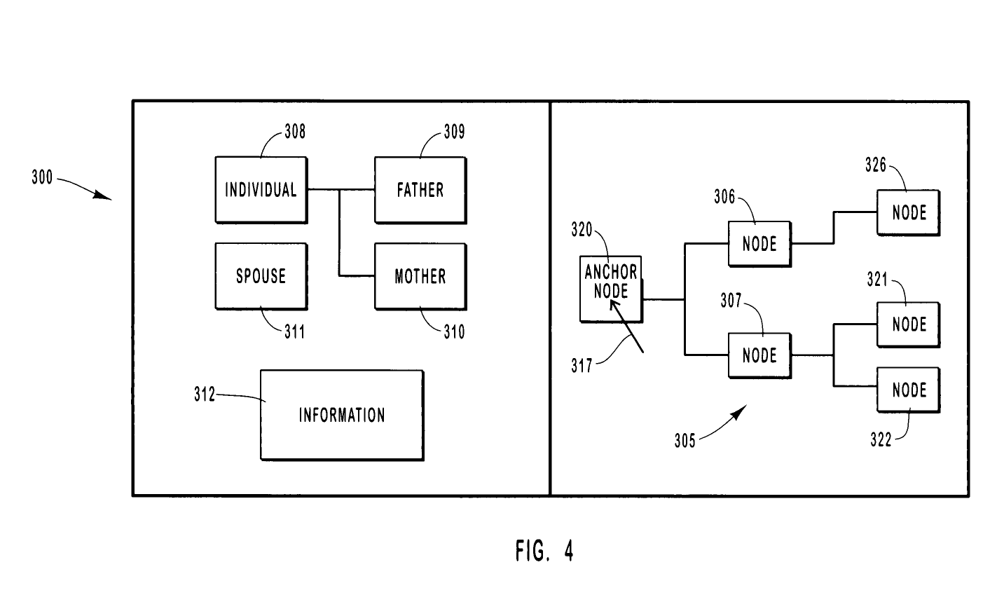

FIG. 4 is a block diagram further illustrating an exemplary view of structure 305 as presented to a user on a display device. Structure 305 is displayed after the nodes have been retrieved from the server 202 and expanded or processed by the client 208. The information or data transmitted, however, in the initial transfer from the server does not typically contain any personal information for the specific individuals represented by the nodes in structure 305. The personal information relating to each specific individual is transferred from the server to the client when a user chooses, selects or otherwise indicates an individual represented by a particular node. When the node is selected or chosen, the identifier in the identifier data field associated with the node is sent to the server. The server uses the unique identifier to gather or retrieve the personal information for that individual from the database and transmit the personal information to the client.

In one embodiment, the node or individual is selected or identified using a mouse pointer 317. When node 320 is selected by a “mouse over,” which means that the mouse pointer 317 moves across the node 320 shown on the display device, then the identifier of the node 320 is sent or transmitted to the server, which returns to the client the personal information of the individual represented by node 320.

The personal information returned by the server is displayed as illustrated in screen shot 300. The name and other personal information such as birth date of the individual is displayed in box 308. Box 309 displays the personal information of the father of the individual and box 310 displays the personal information of the mother of the individual. The spouse's personal information, if present, is displayed in box 311 while box 312 is used to display other personal information including, but not limited to children, siblings, other spouses, other parents, important dates and the like.

It is understood that personal information may be displayed in different manners. In other words, personal information is transmitted as needed or as requested and is often dependent on certain acts by the user, such as a mouse over. However, the user is not required to specifically request the personal information of a particular individual because the request is performed automatically when the user causes the mouse pointer 317 to touch or otherwise indicate a particular node. A significant advantage is that the latency experienced by the user is minimized and the genealogical data can be viewed more quickly. For example, if a user desires to view a pedigree chart having 32 generations, the nodes can be downloaded rather quickly, while the personal information for all of the nodes may require a significant amount of time. After the pedigree chart is constructed and displayed to the user, downloading the personal information of selected individuals requires relatively less time.

After the personal information corresponding to a particular node or individual is downloaded, it may be cached by the client such that further downloads for that individual within a certain time period are no longer necessary. The personal information of the other individuals in the chart 305 is similarly downloaded only when indicated or selected by the mouse pointer 317 or other indicator. This method of downloading information reduces the wait time that the client would otherwise experience. This also enables the client or user to quickly expand the number of generations displayed by structure 305 without having to download a significant amount of additional personal information. In instances where the number of generations or nodes in the chart 305 are few, it is possible to simply download all necessary information including the personal information rather than wait for a particular node to be selected or indicated by a user.

In another embodiment, the systems, methods and data structures described herein may be applied to other types of data. With reference to FIGS. 3a and 3b, the present invention may also be used to describe the relationships that may exist in multi-level marketing systems. In multi-level marketing, the relationships between the salespersons is analogous to an ancestry or descendancy chart. The anchor node 320 would correspond to a particular salesperson and the nodes 306 and 307 would correspond to the salespersons that report the salesperson represented by the node 320.

In FIG. 3b, the father pointer 351 and the mother pointer 352 point to a person's parents. In the context of multi-marketing, a multi-level chart is generated instead of a pedigree chart and the father pointer 351 and the mother pointer 352, rather than pointing to an individual's parent, are next level or adjacent level pointers that point to other salespersons in adjacent levels of the chart that report directly to the selected salesperson. Additionally, the number of pointers used to point to an adjacent level is dependent on the number of persons in the adjacent level. In genealogy, a person is limited to a father and a mother, but in multi-level marketing, a person can be associated with many individuals. In other words, the number of pointers that are used to construct the node 350 at the server is often dependent on the type of data represented by the node. The node 350 can therefore be adapted to many different situations. The terminology of the data fields within the nodes and the data structures can be altered to correspond with the type of data being represented. Thus, pedigree chart, mother, father, child and like terms are used to when representing genealogical data, while terms such as level, salesperson, are used when representing multi-level marketing data.

In the context of multi-level marketing, only the generated nodes are transmitted in the initial transfer from the server to the client. When the client selects a particular node, then the data associated with that node is transferred. In this case, the information may include sales, commissions, hours worked, names of persons in the sales group, and other information that may be relevant to multi-level marketers. In this manner, the nodes can be used to represent data that may be organized by relationships and includes, but is not limited to, DNA sequences, gene sequences, sport tournament brackets, and the like.

An important advantage is that data structure that represents the data can be 3<constructed by initially transmitting nodes that define certain relationships. Preferably, the node created at the server contains minimal information. At the client, the minimal information can be used to derive other relationships. For example, in genealogical data, the previous and next pointers can be used to identify siblings in a descendancy chart. In multi-level marketing data, the child pointers may be used to identify individuals that are in the same sales group. Similar relationships can be derived from other types of data. Finally, the actual information represented by the nodes in the interlinked data structure is downloaded as needed or as requested by a user. In this manner, latency is reduced and the user experience is enhanced.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

I claim:

1. For a system capable of transmitting data from a database maintained by a server system to a client, the database comprising one or more data objects representing one or more individuals, a computer-readable medium having stored thereon a data structure for representing the data so as to reduce latency when transmitting the data, the data structure comprising:
a plurality of nodes, each representing an associated data object which stores an object identifier, relationship data describing how an individual corresponding to the data object is related to one or more other individuals, and at least one of name, date, and place data for the corresponding individual, wherein the plurality of nodes are grouped into one or more levels within a hierarchical chart; and
for each one of the plurality of nodes, a plurality of data fields comprising an object identifier field and one or more relationship fields which reference one or more other nodes in one or more levels of the hierarchical chart, but wherein the plurality of data fields exclude at least some name, date or place data that is stored in the data object represented by the node in order to reduce latency that would otherwise occur when sending or receiving the plurality of nodes, wherein the one or more relationship fields uniquely identify each object represented by each node, without having to reference the at least some name, date, or place data that has been excluded from each node.

2. A data structure as defined in claim 1, wherein the object is an individual.

3. A data structure as defined in claim 1, wherein the plurality of nodes represents genealogical data.

4. A data structure as defined in claim 1, wherein the plurality of nodes represents multi-level marketing data.

5. A data structure as defined in claim 1, wherein the plurality of data fields further comprises:
one or more next level pointers, the next level pointers referencing one or more nodes in a next level; and
one or more previous level pointers, the previous level pointers referencing one or more nodes in a previous level.

6. A data structure as defined in claim 1, wherein the plurality of data fields further comprise:
a next pointer, the next pointer referring to a next node in the same level;
a previous pointer, the previous pointer referring to a previous node in the same level;
a level data field, the generation field identifying a level of each node; and
a y position field for positioning each node within each level on a display device, wherein the next pointer, the previous pointer, the level data field and the y position field are generated at the client.

7. In a system having a server system maintaining a database containing data for a plurality of individuals, the data for each individual comprising (i) at least some name, date, or place data associated with the individual, (ii) one or more relationships to one or more other individuals, and (iii) an individual identifier, a method of transferring at least a portion of the data from the database to a client that reduces latency which otherwise may be associated with the transfer, the method comprising the steps of:
requesting, by a client, data for one or more individuals from a server system;
in response to the request, receiving, from the server system, a plurality of nodes representative of the one or more individuals whose data has been requested by the client, but containing only an initial portion of the requested data by having excluded at least some available name, date, or place data to reduce latency that would otherwise occur from waiting for the excluded data, wherein the initial portion comprises an individual identifier and one or more links to one or more other nodes based on one or more relationships that an individual has to one or more other individuals;
from the one or more links in each node, expanding the plurality of nodes at the client to produce a client data structure representative of the requested data; and for one or more selected nodes, receiving a subsequent portion of the requested data that comprises at least some of the name, date, or place data which was excluded from the received nodes to reduce latency.

8. A method as defined in claim 7, wherein the client data structure is a pedigree chart representative of genealogical data.

9. A method as defined in claim 7, wherein the client data structure is a chart representative of multi-level marketing data.

10. A method as defined in claim 7, wherein the each of the plurality of nodes comprises one or more server data fields.

11. A method as defined in claim 10, wherein the one or more server data fields are expanded at the client to generate additional client data fields.

12. A method as defined in claim 11, wherein the server data fields and the client data fields define relationships between the plurality of nodes.

13. For a system capable of transmitting genealogical data from a database stored by a server to a client, the database comprising one or more data objects representing one or more individuals, a computer-readable medium having stored thereon a data structure for representing the genealogical data so as to reduce latency when transmitting the data, the data structure comprising:
a plurality of nodes, each representing an individual in a pedigree chart, the individual having at least one of name, date, and place data associated with the individual, wherein one of the plurality of nodes is an anchor node, and wherein the plurality of nodes are grouped into one or more generations of the pedigree chart; and
for each one of the plurality of nodes, a plurality of data fields comprising an individual identifier field and one or more relationship fields which reference one or more other nodes in the one or more generations of the pedigree chart, but wherein the plurality of data fields exclude at least some name, date, or place data that is associated with the individual in order to reduce latency that would otherwise occur when transferring the plurality of nodes, wherein the one or more relationship fields uniquely identify each individual represented by each node, without having to reference the at least some name, date, or place data that has been excluded from each node.

14. A data structure as defined in claim 13, wherein the anchor node comprises the first generation of the pedigree chart.

15. A data structure as defined in claim 13, wherein each of the one or more generations comprises at least one node.

16. A data structure as defined in claim 13, wherein the plurality of data fields further comprises:
a father pointer, the father pointer referencing a node in a next generation;
a mother pointer, the mother pointer referencing a node in the next generation; and
a child pointer, the child pointer referencing a node in a previous generation.

17. A data structure as defined in claim 13, wherein the plurality of data fields further comprises a flags field, the flags field capable of representing characteristics of the individual represented by each node.

18. A data structure as defined in claim 13, wherein the plurality of data fields further comprises an identifier field, the identifier field uniquely identifying the individual represented by each node from all other individuals stored on the database.

19. A data structure as defined in claim 13, wherein the plurality of data fields further comprise:
a next pointer, the next pointer referring to a next node in the same generation;
a previous pointer, the previous pointer referring to a previous node in the same generation;
a generation data field, the generation field identifying a generation of each node; and
a y position field for positioning each node within each generation on a display device, wherein the next pointer, the previous pointer, the generation data field, and the y position field are generated at the client.

20. In a system having a server maintaining a database containing genealogical data for a plurality of individuals, the genealogical data for each individual comprising at least some name, date, or place data associated with the individual, one or more relationships to one or more other individuals, and an individual identifier, wherein the genealogical data is accessible by a client, a method for transferring the genealogical data from the database to a client, the method comprising the acts of:
requesting, by a client, genealogical data associated with a plurality of individuals from a server;
in response to the request, receiving, from the server, a plurality of nodes representative of the plurality of individuals whose genealogical data has been requested by the client, but containing only an initial portion of the request data, the initial portion excluding at least some available name, date, or place data for one or more individuals to reduce latency that would otherwise occur from receiving the excluded data with the initial portion, wherein for each of the plurality of individuals represented by the plurality of nodes, the initial portion comprises one or more relationships to one or more other individuals;
from the one or more relationships for each of the plurality of individuals, expanding the plurality of nodes at the client to produce a client data structure representative of a pedigree chart; and
for one or more selected nodes, requesting and receiving a subsequent portion of the requested genealogical data from the database that comprises at least some of the name, date, or place data which was excluded from the received plurality of nodes to reduce latency.

21. A method as defined in claim 20, wherein the plurality of nodes are generated by the server and form a server data structure having one or more generations, wherein the nodes in adjacent generations are linked.

22. A method as defined in claim 21, wherein the server data structure is expanded to generate the client data structure having one or more generations, wherein the nodes in a same generation are linked together and the nodes in adjacent generations are linked.

23. A method as defined in claim 20, wherein each individual represented by each node is identified by family relationships.

24. A method as defined in claim 22 wherein each of the plurality of nodes in the server data structure comprises one or more data fields, the one or more server data fields comprising:
a father pointer for indicating a node in a next generation representative of a father if known;
a mother pointer for indicating a node in a next generation representative of a mother if known;
a child pointer for indicating a node in a previous generation representative of a child if known;
a flag data field for representing characteristics of the individual associated with the node; and
an identifier data field for uniquely identifying the individual from all other individuals.

25. A method as defined in claim 24, wherein each of the plurality of nodes of the client data structure comprises:
the one or more server data fields of the server data structure; and
one or more client data fields comprising:
a next pointer for identifying a next node in a same generation;
a previous pointer for identifying a previous node in the same generation; and
a y position node for positioning the nodes of the same generation on a display device.

26. A method as defined in claim 21, wherein the server data structure is expanded to generate the client data structure.

27. A method as defined in claim 25, wherein the act of expanding the plurality of nodes further comprises the acts of:
determining a generation data field for each node;
determining the y position data field for each node; and
determining the next and previous pointer data fields based on the y position data fields of nodes having the same generation data field.

28. A method as defined in claim 20 further comprising the act of displaying the genealogical information for each node selected by a user.

29. In a system having a client capable of receiving genealogical data from a database through a server, wherein for each of one or more individuals the database comprises at least some name, date, or place data for the individual, relationship data describing how the individual is related to one or more other individuals, and an individual identifier, a method for displaying a pedigree chart at the client, the method comprising the steps of:
receiving a plurality of nodes from the server, wherein the plurality of nodes are representative of individuals in the pedigree chart, but contain only an initial portion of data associated with the individuals, wherein for each node the initial portion comprises and individual identifier and one or more relationships to one or more other nodes representing one or more other individuals, but excludes at least some associated genealogical data to reduce latency that would otherwise occur from receiving the excluded data with the initial portion;
from the one or more relationships in each node, expanding the plurality of nodes at the client to generate a client data structure representative of the pedigree chart;
in response to a user selecting one of the nodes in the client data structure, retrieving at least a portion of the excluded genealogical data associated with the selected node from the database; and
displaying the at least a portion of the excluded genealogical information associated with the selected node at the client.

30. A method as defined in claim 29, wherein the step of receiving a plurality of nodes from the server further comprises the steps of:
generating, by the server, the plurality of nodes in response to a request for genealogical data from the client; and
linking the plurality of nodes according to family relationships.

31. A method as defined in claim 30, wherein the step of linking the plurality of nodes further comprises the step of generating a plurality of server data fields for each node.

32. A method as defined in claim 31, wherein the server data fields comprise:
a father pointer data field pointing to a father node in a next generation;
a mother pointer data field pointing to a mother node in the next generation;
a child pointer data field pointing to a child node in a previous generation;
a flags data field; and
an identification data field for uniquely identifying the individual from all other individuals stored in the database.

33. A method as defined in claim 32, wherein the server data fields are compressed before the plurality of nodes is transmitted to the client.

34. A method as defined in claim 29, wherein the step of expanding the plurality of nodes further comprises the steps of:
generating client data fields for each of the nodes, the client data fields comprising:
a next pointer pointing to a next node in a same generation;
a previous pointer pointing to a previous pointer in the same generation;
a generation data field to identify a generation of each node; and
a y position field to position, at the client, all nodes having identical generation data fields.

35. A method as defined in claim 29, wherein the client data structure is a linked data structure representative of genealogical information requested by the client.

36. A method as defined in claim 29, wherein the client data structure does not contain genealogical data.

37. A method as defined in claim 29, wherein a user selects a node with a mouse over.

38. A method as defined in claim 29, wherein the genealogical data retrieved by the client is cached by the client.

39. A computer program product for implementing, in a system having a client capable of accessing a genealogical database through a server, wherein for each of one or more individuals the database comprises at least some name, date, or place data for the individual, relationship data describing how the individual is related to one or more other individuals, and an individual identifier, a method for displaying a pedigree chart at the client, the computer program product comprising:
a computer readable medium carrying computer executable instructions for implementing the method, wherein the computer executable instructions comprise:
receiving a plurality of nodes from the server, wherein the plurality of nodes are representative of individuals in the pedigree chart, but contain only an initial portion of data associated with the individuals, wherein for each node the initial portion comprises and individual identifier and one or more relationships to one or more other nodes representing one or more other individuals, but excludes at least some associated genealogical data to reduce latency that would otherwise occur from receiving the excluded data with the initial portion;
from the one or more relationships in each node, expanding the plurality of nodes at the client to generate a client data structure representative of the pedigree chart;
in response to a user selecting one of the nodes, retrieving at least a portion of the excluded genealogical data associated with the selected node from the database; and
displaying the at least a portion of the excluded genealogical information associated with the selected node at the client.
